(19) United States
(12) Patent Application Publication
(10) Pub. No.: US 2025/0140249 A1
(43) Pub. Date: May 1, 2025

(54) VOICE INPUT DISAMBIGUATION

(71) Applicant: Google LLC, Mountain View, CA (US)

(72) Inventors: Matthew Sharifi, Kilchberg (CH); Jyrki Antero Alakuijala, Wollerau (CH); Dirk Ryan Padfield, Seattle, WA (US)

(21) Appl. No.: 18/564,884

(22) PCT Filed: Nov. 9, 2022
(86) PCT No.: PCT/US2022/049423

§ 371 Date: Nov. 28, 2023

(51) Int. Cl. G10L 15/22; G10L 15/183

(52) U.S. Cl. CPC G10L 15/22; G10L 15/183

(57) ABSTRACT

A method for recognizing a voice input includes receiving a first voice input including a plurality of terms, processing the first voice input based on the plurality of terms to obtain a first speech recognition result including one or more candidate terms corresponding to one or more terms from the plurality of terms, receiving a second voice input providing at least one of contextual information relating to the first voice input or confirmation information relating to the one or more candidate terms, and processing the second voice input based on the at least one of the contextual information or the confirmation information to obtain a second speech recognition result including at least one of the one or more candidate terms or one or more new candidate terms, as corresponding to the one or more terms from the plurality of terms.

### FIELD

The disclosure relates generally to speech recognition. For example, the disclosure relates to methods and speech recognition systems for speech recognition which resolve ambiguities of a user voice input.

### BACKGROUND

Current speech recognition systems may struggle to properly recognize a voice input from a single utterance which includes terms susceptible to multiple possible pronunciations or which includes terms from different languages (e.g., “navigate to La Grenouille” has a wide variety of possible pronunciations and includes terms from English and French). In addition, current speech recognition systems may struggle to identify a correct result (e.g., a place) where there are many candidates which appear to satisfy the voice input.

### SUMMARY

Aspects and advantages of embodiments of the disclosure will be set forth in part in the following description, or can be learned from the description, or can be learned through practice of the example embodiments.

In one or more example embodiments, a computer implemented method for speech recognition is provided. For example, the method includes receiving a first voice input including a plurality of terms, processing the first voice input based on the plurality of terms to obtain a first speech recognition result including one or more candidate terms corresponding to one or more terms from the plurality of terms, receiving a second voice input providing at least one of contextual information relating to the first voice input or confirmation information relating to the one or more candidate terms, and processing the second voice input based on the at least one of the contextual information or the confirmation information to obtain a second speech recognition result including at least one of the one or more candidate terms or one or more new candidate terms, as corresponding to the one or more terms from the plurality of terms.

In some implementations, the method may include requesting the at least one of the contextual information relating to the first voice input or the confirmation information relating to the one or more candidate terms.

In some implementations, the method may include processing the first voice input by implementing one or more speech recognition models with respect to the first voice input.

In some implementations, implementing the one or more speech recognition models with respect to the first voice input includes implementing a plurality of speech recognition models with respect to the first voice input including implementing a first speech recognition model among the plurality of speech recognition models with respect to at least a portion of an entire utterance associated with the first voice input, and implementing a second speech recognition model among the plurality of speech recognition models with respect to at least the portion of the entire utterance associated with the first voice input.

In some implementations, the first speech recognition model corresponds to a default language associated with a user providing the first voice input and the second speech recognition model corresponds to a language associated with a location of the user providing the first voice input.

In some implementations, the first speech recognition model corresponds to a default language associated with a user providing the first voice input and the second speech recognition model corresponds to a language, other than the default language, which is associated with the one or more terms from the plurality of terms.

In some implementations, the first speech recognition model corresponds to a default language associated with a user providing the first voice input, the first speech recognition model being implemented with respect to the entire utterance associated with the first voice input, and the second speech recognition model corresponds to a language other than the default language. When a recognition confidence of the first speech recognition model with respect to portions of the entire utterance associated with the first voice input is less than a threshold confidence level, the method includes implementing the second speech recognition model with respect to the portions of the entire utterance associated with the first voice input.

In some implementations, the first speech recognition model corresponds to a default language associated with a user providing the first voice input, the first speech recognition model being implemented with respect to the entire utterance associated with the first voice input, and the second speech recognition model is implemented with respect to portions of the entire utterance associated with the first voice input which are in a language other than the default language.

In some implementations, the one or more terms from the plurality of terms include information associated with a first point of interest, the contextual information provided in the second voice input includes a second point of interest associated with the first point of interest, and processing the second voice input based on the contextual information includes determining whether the second point of interest is associated with the at least one of the one or more candidate terms or the one or more new candidate terms.

In some implementations, processing the second voice input based on the contextual information includes weighting a first candidate term corresponding to a first candidate point of interest more heavily compared to a second candidate term corresponding to a second candidate point of interest, wherein the first candidate point of interest is physically located closer to the second point of interest than the second candidate point of interest.

In some implementations, the one or more terms from the plurality of terms include information associated with a first point of interest, the contextual information provided in the second voice input includes attribute information about the first point of interest, and processing the second voice input based on the contextual information includes determining whether the at least one of the one or more candidate terms or the one or more new candidate terms is associated with the attribute information.

In some implementations, processing the second voice input based on the contextual information includes weighting a first candidate term corresponding to a first candidate point of interest more heavily compared to a second candidate term corresponding to a second candidate point of interest, where attribute information of the first candidate point of interest is more similar to the attribute information associated with the first point of interest than attribute information associated with the second candidate point of interest

In some implementations, the method includes determining respective matching scores between a first term from the plurality of terms included in the first voice input and each candidate term corresponding to the first term, and providing a prompt to a user associated with the first voice input, the prompt requesting at least one of contextual information relating to the first term or confirmation information relating to each candidate term corresponding to the first term, in response to determining none of the respective matching scores exceed a threshold matching level or in response to determining a plurality of the respective matching scores exceed the threshold matching level.

In some implementations, when each candidate term is associated with a different type of point of interest, providing the prompt requesting at least one of contextual information relating to the first term or confirmation information relating to each candidate term corresponding to the first term includes providing a prompt to the user to identify a type of point of interest associated with the first term.

In some implementations, when a candidate term is associated with a differentiating attribute, providing the prompt requesting at least one of contextual information relating to the first term or confirmation information relating to the candidate term corresponding to the first term includes providing a prompt to the user to identify whether the differentiating attribute is associated with the first term.

In some implementations, processing the first voice input includes implementing one or more speech recognition models with respect to the first voice input, and when the second voice input includes at least one term associated with one or more languages different from languages associated with the one or more speech recognition models, the method includes re-processing the first voice input by implementing one or more further speech recognition models with respect to the first voice input to obtain the second speech recognition result.

In one or more example embodiments, a speech recognition system is provided. The speech recognition system may include at least one memory to store instructions, and at least one processor configured to execute the instructions to perform operations, the operations including: receiving a first voice input including a plurality of terms, processing the first voice input based on the plurality of terms to obtain a first speech recognition result including one or more candidate terms corresponding to one or more terms from the plurality of terms, receiving a second voice input providing at least one of contextual information relating to the first voice input or confirmation information relating to the one or more candidate terms, and processing the second voice input based on the at least one of the contextual information or the confirmation information to obtain a second speech recognition result including at least one of the one or more candidate terms or one or more new candidate terms, as corresponding to the one or more terms from the plurality of terms.

In some implementations, the operations further include: determining respective matching scores between a first term from the plurality of terms included in the first voice input and each candidate term corresponding to the first term, and providing a prompt requesting at least one of contextual information relating to the first term or confirmation information relating to each candidate term corresponding to the first term, in response to determining none of the respective matching scores exceed a threshold matching level or in response to determining a plurality of the respective matching scores exceed the threshold matching level.

In one or more example embodiments, a computing system (e.g., a computing device, a server computing system, or combinations thereof) for speech recognition is provided. The computing system may include the speech recognition system and a functional system configured to execute one or more operations of the computing system in response to a matching score between the second speech recognition result and the one or more terms from the plurality of terms exceeding a threshold matching level.

In some implementations, the operations further include: determining respective matching scores between a first term from the plurality of terms included in the first voice input and each candidate term corresponding to the first term, and providing a prompt requesting at least one of contextual information relating to the first term or confirmation information relating to each candidate term corresponding to the first term, in response to determining none of the respective matching scores exceed a threshold matching level or in response to determining a plurality of the respective matching scores exceed the threshold matching level.

In one or more example embodiments, a computer-readable medium (e.g., a non-transitory computer-readable medium) which stores instructions that are executable by one or more processors of a computing system is provided. In some implementations the computer-readable medium stores instructions which may include instructions to cause the one or more processors to perform one or more operations of any of the methods described herein (e.g., operations of the server computing system and/or operations of the computing device). The computer-readable medium may store additional instructions to execute other aspects of the server computing system and computing device and corresponding methods of operation, as described herein.

These and other features, aspects, and advantages of various embodiments of the disclosure will become better understood with reference to the following description, drawings, and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of example embodiments directed to one of ordinary skill in the art is set forth in the specification, which makes reference to the appended drawings, in which:

FIG. 1 depicts an example system according to according to one or more example embodiments of the disclosure;

FIG. 2 depicts example block diagrams of a computing device and a server computing system according to one or more example embodiments of the disclosure;

FIG. 3 illustrates a flow diagram of an example, non-limiting computer-implemented method, according to one or more example embodiments of the disclosure; and

FIG. 4 illustrates a flow diagram of an example, non-limiting computer-implemented method, according to one or more example embodiments of the disclosure.

### DETAILED DESCRIPTION

Reference now will be made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

Examples of the disclosure are directed to a computer-implemented speech recognition method and speech recognition systems for speech recognition which resolve ambiguities of a user voice input.

According to example embodiments a speech recognition system may include a computing application (e.g., a navigation application, an infotainment application, a climate control application, etc.) which receives a voice input from a user such as “Navigate to La Grenouille.” The computing system may execute a speech recognition application in association with the computing application to transcribe the voice input and match the resulting transcription against potential candidate terms which are ranked. When the computing or speech recognition application is not confident about the top candidate term (e.g., a confidence level is below a threshold level), the computing or speech recognition application may be configured to request feedback from the user, for example, by seeking clarification or confirmation regarding one or more top candidate terms, or may ask for additional, contextual, information. For example, the computing or speech recognition application may request contextual information such as the type of place associated with the voice input or may identify one or more top candidate terms to the user to obtain a confirmation from the user regarding the top candidate term (e.g., “What type of place is it? I found La Grande Park in New Jersey”). The user may provide another voice input providing the confirmation or the contextual information, in response to the output from the computing or speech recognition application. In response to receiving the additional voice input from the user providing the confirmation or the contextual information, the computing or speech recognition application may refine or re-rank the potential candidate terms (or obtain new candidate terms) and provide another output to the user. In some implementations, the computing or speech recognition application may again request additional contextual information such as a location associated with the one or more updated top candidate terms or may identify the one or more updated top candidate terms to the user (e.g., “I've found La Grande Boucherie or La Grenouille. They're both in midtown”). In some implementations, the user may provide a further voice input responding to the output from the computing or speech recognition application providing confirmation or contextual information (e.g., “the second one” and/or “it's next to my favorite chocolate shop”). In response to receiving the further voice input from the user providing the confirmation or the contextual information, the computing or speech recognition application may confirm the selection of the candidate term to the user and/or confirm that the selected candidate term is associated with the contextual information (e.g., “Navigating to La Grenouille” and/or “It's on the same block as Neuhaus Belgian Chocolate”). The computing application may perform a function in association with the confirmed voice input (e.g., navigating to the identified destination, controlling a setting of an appliance, a climate system, an infotainment system, etc.).

In some implementations, the speech recognition application may be configured to identify that an utterance (voice input) from the user includes one or more terms from a secondary language (i.e., a language other than one or more default languages associated with the user and/or one or more terms which have a recognition confidence below a threshold level with respect to the one or more default languages). For example, the one or more default languages may include one or more languages of the user (e.g., as indicated via a user profile, device or operating system setting, by analysis of the user's speech, by an input or selection of the user, etc.). For example, the speech recognition application may be configured to execute speech recognition in the one or more default languages via one or more primary speech recognition models and via one or more secondary speech recognition models. For example, the one or more secondary speech recognition models may be associated with one or more languages other than the one or more default languages. For example, the one or more secondary speech recognition models may be associated with one or more languages associated with a location of the user, with one or more languages associated with the utterance (e.g., if a user identifies a country or language in the utterance itself or in an associated voice input), and the like. In some implementations, the speech recognition application may be configured to execute speech recognition in the one or more default languages via the one or more primary speech recognition models and in the recognized secondary language via the one or more secondary speech recognition models in parallel.

In some implementations, the speech recognition application may be configured to execute speech recognition in all available speech recognition models including the one or more primary speech recognition models for the entire utterance. In some implementations, the speech recognition application may be configured to execute speech recognition in the one or more default languages via the one or more primary speech recognition models and in the one or more secondary speech recognition languages via the one or more secondary speech recognition models over the entire utterance.

In some implementations, the speech recognition application may be configured to execute speech recognition in the one or more secondary languages via the one or more secondary speech recognition models for only those terms from the utterance which are identified as being in a secondary language and/or having a low recognition confidence while executing speech recognition in the one or more default languages via the one or more primary speech recognition models for the entire utterance or for the remaining terms of the utterance not being processed by the one or more secondary speech recognition models. In some implementations, the speech recognition application may be configured to execute speech recognition in the one or more secondary languages via the one or more secondary speech recognition models for all of the terms from the utterance if at least one term (segment) is identified as being in a secondary language and/or having a low recognition confidence while executing speech recognition in the one or more default languages via the one or more primary speech recognition models for the entire utterance or for the remaining terms of the utterance not identified as being in a secondary language and/or having a low recognition confidence. In some implementations, the speech recognition application may be configured to execute speech recognition in all available speech recognition models (other than the one or more primary speech recognition models) for only those terms from the utterance which are identified as being in a secondary language while executing speech recognition in the one or more default languages via the one or more primary speech recognition models for the entire utterance or for the remaining terms of the utterance not being processed by the one or more available speech recognition models. In some implementations, the secondary speech recognition models can be implemented in a sequential or chain fashion so that an Nth secondary speech recognition model is implemented only when there are low confidence segments from all of the prior 0 to (N−1)th secondary speech recognition models. Limiting speech recognition by the one or more secondary speech recognition models to certain terms from the entire utterance which are identified as belonging to a secondary language can reduce usage of computer resources such as memory, power, and bandwidth, and can conserve the battery and/or useful life of computing devices which are configured to perform some or all of the operations associated with speech recognition of terms identified as belonging to the secondary language. For example, speech recognition may be executed by the user's computing device, by a server computing device remotely located from the user, by another external computing device, or combinations thereof.

In some implementations, when the computing or speech recognition application is not confident about the top candidate term (e.g., a confidence level is below a threshold level) due to a plurality of candidate terms which match the criteria of the voice input from the user, the computing or speech recognition application may be configured to request feedback from the user, for example, by seeking clarification or confirmation regarding one or more top candidate terms, or may ask for additional information. For example, the computing or speech recognition application may request whether the user has a preference for a particular candidate term, identify candidate terms which may have characteristics or features that match a user preference or are unique or different compared to other candidate terms (e.g., a candidate term that is physically closer to the user, next to a landmark, has operating hours convenient to the user or different from other candidate terms, environmental conditions favored by the user compared to other candidate terms, etc.). For example, if multiple restaurants having the same name are located in Seattle, the computing or speech recognition application may output a query such as “Is it next to the Space Needle?”, to disambiguate between a restaurant located relatively closer to the Space Needle compared to the other restaurants. The user may provide another voice input in response to the output from the computing application providing the confirmation or the contextual information. In response to receiving the additional voice input from the user providing the confirmation or the contextual information, the computing or speech recognition application may refine or re-rank the potential candidate terms (or obtain new candidate terms) and provide another output to the user either identifying a top ranked candidate term or requesting further information. The computing or speech recognition application may confirm the selection of the top ranking candidate term or candidate term having a highest confidence value to the user and perform a function in association with the selected candidate term (e.g., navigating to the identified destination, controlling a setting of an appliance, a climate system, an infotainment system, etc.).

As a non-limiting example, a user may initiate a first voice input to a computing application (e.g., a navigation application), such as “Navigate to Restaurant A in midtown.” The navigation application (in conjunction with the speech recognition application) may determine a plurality of restaurants with the same name are present in or near midtown, and provide an output (e.g., via a speaker or a display) such as “There are 4 matching restaurants in midtown, all with similar travel times from your current location. Do you have any preference which one to go to?”. The user can now respond with a second voice input identifying specific attributes, such as “I prefer the one close to Landmark X” or “I would prefer the one with outdoor seating.” The speech recognition application may be configured to process the second voice input and confirm the selected choice “Ok, Restaurant A on 5th Ave is closest to Landmark X” or “Ok, Restaurant B on 8th Ave has outdoor seating” and a navigation application may be configured to start navigation to the restaurant matching the attributes identified by the user in the second voice input.

In some implementations, a user may initiate execution of the computing application by selecting the computing application manually, by a voice input, or another input method. In some implementations, the computing application may be triggered via an external application such as an assistant application.

In some implementations, a user may initiate the voice input through a spoken hotword which identifies the application to process the voice input (e.g. “Hey ‘Name of Computing Application’”), through another user interface such as a physical button (e.g., a button on a steering wheel, a touchscreen on a smartphone, a button on the user's headphones, etc.).

The user may next provide the voice input to a computing device having a speech recognition system itself or access to a speech recognition system remotely. The voice input may be for the purpose of operating a component of the computing device itself or for operating a component of another device. That is, in response to providing the voice input, a function may be carried out via the computing application (e.g., a navigation function for a vehicle, a function such as providing an answer to a question, a function such as operating an appliance or infotainment system, etc.).

In response to receiving the voice input, the computing application and/or speech recognition application may be configured to implement one or more speech recognition models to process the voice input, as discussed above.

In response to processing the voice input, via the one or more speech recognition models, the computing application and/or speech recognition application may be configured to parse the output of the one or more speech recognition models. For example, the output of the one or more speech recognition models may be parsed using a natural language understanding model. The natural language understanding model may be any machine-learned model (e.g., a deep neural network) which extracts an intent and also slot values. The user's intent (e.g., NAVIGATE, DIRECTIONS) may be recognized to determine how the query should be handled. Possible transcriptions for the query (e.g., place name) slot value are then fed to subsequent operations which are described below. For each language a N-best hypotheses may be provided by the speech recognition system, or an intermediate representation from the model may be provided rather than a textual hypothesis. In addition, specific hints that the user provides in the query may be parsed. For example, hints can include information such as contextual information that can be used to update or refine the transcription(s) or obtain a new candidate transcription(s). For example, a hint for a query concerning a point of interest can include things like “the restaurant,” “the French restaurant,” “it's next to the lake,” etc.

In some implementations, the speech recognition application may be configured to resolve all of the hypotheses terms (e.g., place name hypotheses) that are obtained from different speech recognition models for example, against known terms (e.g., known place names) that may be stored in a memory or database. The memory or database can be located on the user's computing device (e.g., for offline mapping), or provided remotely in the cloud (e.g., stored in a server or database), or a combination thereof. The speech recognition application may be configured to perform matching between the hypotheses terms and known terms via fuzzy string matching (e.g., based on edit distance or some related metric). As another example, the speech recognition application may be configured to additionally (or alternatively) perform matching between the hypotheses terms and known terms via a phonetic distance to ensure that two similar sounding words have a low distance even if the edit distance would be high.

In some implementations, possible matches between the hypotheses terms and known terms may be further refined based on additional information (i.e., hints) provided via the user. For example, a user may provide an input confirming certain information or may provide contextual information or attribute information which can be applied to filter down the possible matches between the hypotheses terms and known terms. In some implementations, the additional information can be applied before a matching operation is performed. For example, a user may specify Restaurant A is in the south part of City A or is a French restaurant in City A. The speech recognition application may be configured to consider a subset of restaurants in City A rather than all of the restaurants in City A when comparing the hypotheses restaurants against known restaurants. Such a filtering operation prior to the matching operation can improve efficiencies of the speech recognition system as well as other systems (e.g., navigation systems and databases such as a maps stack, as searching for matching places can be performed with additional filters and fewer candidates are considered) and therefore conserve or reduce usage of computing resources. The additional information (i.e., hints) provided by the user may be matched against precomputed attributes for each known term. For example, attribute information may be associated with a term (e.g., a place) via various methods. For example, such attribute information may be determined based on information associated with a user profile (e.g., user preferences such as favorite restaurants, favorite foods or places, modes of travel of the user, etc.), information associated with mapping data (e.g., determining a relative location of a point of interest to another point of interest, to a city center, etc.), information associated with a term that is obtained from an external data source such as webpages, analysis of imagery or photos, etc. (e.g., hours of operation, real-time conditions, weather information, time information, etc.). For example, a user may provide contextual information about a first point of interest that can resolve an ambiguity between two candidate points-of-interest (e.g., “it's the restaurant next to my favorite music store”).

The speech recognition system may be configured to determine (calculate) a matching score between what the user said and each candidate term (e.g., a candidate place name). Other existing ranking signals may also be incorporated. In some implementations, if a matching score for only one of the candidate terms exceeds a threshold matching level (i.e., there is only one high scoring candidate term), there is no need for disambiguation (or for further disambiguation) and the speech recognition system can provide an output which may be used by a computing system (e.g., an electronic device such as a smartphone, a vehicle, a home appliance, etc.) to perform an operation, action, or function based on the output. In such a case the speech recognition system can provide the output without a user confirmation, however in some implementations (e.g., if the function to be performed is safety related, is not time sensitive, etc.) the speech recognition system may request user confirmation.

In some implementations, if a matching score for a plurality of candidate terms exceeds a threshold matching level (i.e., there are multiple high scoring candidate term) and the number of such candidate terms is less than a threshold level (e.g., less than five, less than three), the speech recognition system can provide an output which identifies the plurality of candidate terms and request the user to identify or confirm one of the plurality of candidate terms as the correct selection (if it is provided).

In some implementations, if a matching score for a plurality of candidate terms does not exceed a threshold matching level (i.e., there is no high scoring candidate term), the speech recognition system can implement a disambiguation operation to determine which candidate term to select or to determine a subset of the plurality of candidate terms to offer as possible outputs based on additional information to be provided to the speech recognition system.

For example, the disambiguation operation may include generating a prompt based on a subset or pool of available candidate terms, which is provided to the user (e.g., via an output device such as a speaker, a display device, etc.). For example, if the speech recognition system determines the plurality of candidate terms correspond to different types of places, the speech recognition system may provide a prompt requesting the user to verify the type of place, such as “Did you mean the restaurant or the museum?”. As another example, different types of attributes can be used by the speech recognition system to disambiguate between a plurality of candidate terms, which can be general attributes or specific to the user. For example, if the speech recognition system determines one of the plurality of candidate terms is located near a landmark or geographic feature, the speech recognition system may provide a prompt relating to a general attribute such as “the one next to the lake?”. For example, if the speech recognition system determines one of the plurality of candidate terms is located near a point of interest that is known to or preferred by the user, the speech recognition system may provide a prompt relating to a user specific attribute such as “the one next to your favorite cafe?”. For example, if the speech recognition system determines one of the plurality of candidate terms has an attribute other candidate terms do not, and such an attribute is preferred by the user, the speech recognition system may provide a prompt relating to the user specific attribute such as “the one with outdoor seating?”.

As mentioned above, the prompt may be output via an output device such as a speaker or display device. The speech recognition system may receive further inputs from the user via an input device such as a microphone, touch input, etc. In the case of another voice input which is provided in response to a prompt from the speech recognition system, the further utterance may be processed in the manner discussed herein (e.g., by executing one or more speech recognition models, parsing the output from the one or more speech recognition models, and determining matching scores between possible matches between hypotheses terms and known terms).

In some implementations, when the further utterance is processed, attributes which are included in the further utterance may be used to select or replace speech recognition models that were used for the initial (original) voice input. For example, if the user states “it's an Italian restaurant” in response to receiving a prompt from the speech recognition system, an Italian language speech recognition model may be implemented to recognize the place name in the initial (original) voice input and may be additionally implemented to recognize terms from the further utterance. If the set of speech recognition models would not change then no changes to the speech recognition models would be implemented and the speech recognition application would not be executed to recognize terms from the initial (original) voice input and would instead be executed with respect to only the further utterance.

Given the additional attributes received by the speech recognition system from the user in the further utterance, the speech recognition system is configured to recompute matching scores and determine whether further clarification questions should be asked, or if a single candidate term if has a matching score which exceeds a threshold matching level (i.e., there is only one high scoring candidate term), such that there is no need for further disambiguation. Then the speech recognition system can provide an output which may be used by a computing system (e.g., an electronic device such as a smartphone, a vehicle, a home appliance, etc.) to perform an operation, action, or function based on the output. For example, a functional system (e.g., a navigation system, a climate control system, an infotainment system, an engine system, an electrical system, an application, etc.) may perform an operation, action, or function associated with the functional system based on the output (e.g., navigating to a destination, performing a heating or cooling operation, playing music or video, starting a vehicle, changing a lighting condition, executing an application or a function of the application, etc.).

For example, the speech recognition system may be configured to generate a plurality of prompts until only a single candidate term (e.g., a point of interest) remains with a matching score exceeding the matching threshold level. The speech recognition system can then provide an output which may be used by a computing system (e.g., an electronic device such as a smartphone, a vehicle, a home appliance, etc.) to perform an operation, action, or function based on the output (e.g., start navigation, generate directions) with respect to the resolved candidate term.

Each time the speech recognition system performs a successful disambiguation flow, the speech recognition system can use the process as a signal for running personalized and/or federated training of speech recognition models. For example, the user's utterance may correspond to the input signal and the disambiguated candidate term (e.g., a point of interest name) may correspond to a label. In the case of personalization, the speech recognition system may correctly recognize instances when the user says the same utterance in the future. In the federated setting, the change or training of the speech recognition models may be applied across the entire user population.

One or more benefits of the disclosure include allowing users to easily and more accurately input a voice input to a speech recognition system, thus saving the user time and attention from having to manually input a query through a touch-based user interface, which in some instances may not be safe, possible, or practical due to the user engaging in another activity such as driving or cycling. According to examples of the disclosure, a query (e.g., a place or point of interest) can be accurately processed by a speech recognition system thus avoiding situations where a wrong output is obtained (e.g., a destination other than that intended by the user is obtained or are unique compared to other candidate terms, etc.), which can result in increased computing resources being used due to a user having to repeat the query (e.g., additional processing power being used, additional power or battery life being depleted due to additional queries needed, additional bandwidth usage, etc.). According to examples of the disclosure, a query (e.g., a place or point of interest) can be accurately processed by a speech recognition system which, in the case of a navigation application for example, can save vehicle resources (e.g., fuel consumption, battery consumption, etc.) by avoiding situations where the vehicle is navigated to a wrong destination (e.g., avoid navigating to the wrong place in the situation where there are two or more places with a similar or the same name such as more than one restaurant having the same name in a city or a certain part of a city). According to examples of the disclosure, a query (e.g., a query concerning a place or point of interest) can be accurately processed by a speech recognition system which can improve the safety of operating a user interface, for example, in cases where a user needs to focus their attention on other activities (e.g., driving, cycling, etc.), rather than manually operate a user interface by having to look at the user interface to provide an input (e.g., using a finger to type in a destination or other type of query).

According to examples of the disclosure, a query (e.g., a place or point of interest) that includes terms from more than one language can be efficiently processed by a speech recognition system which selectively processes a query using a plurality of language models. Limiting speech recognition by the one or more secondary models to certain terms from the entire utterance which are identified as belonging to a secondary language can reduce usage of computer resources such as memory, power, and bandwidth, and can conserve the battery and/or useful life of computing devices which are configured to perform some or all of the operations associated with speech recognition of terms identified as belonging to the secondary language.

Thus, according to aspects of the disclosure, technical benefits such as resource savings and location accuracy improvements may be achieved.

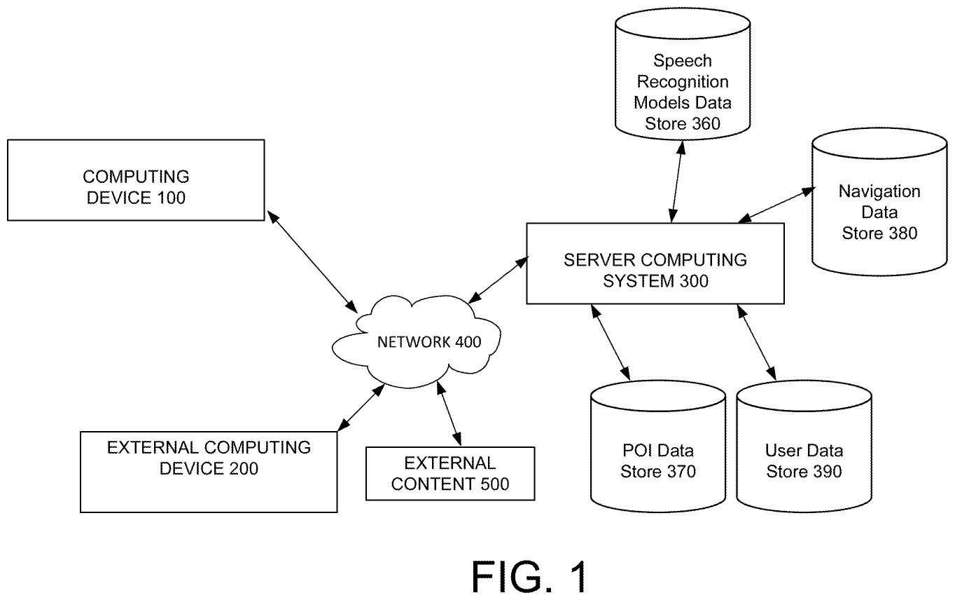

Referring now to the drawings, FIG. 1 is an example system according to one or more example embodiments of the disclosure. FIG. 1 illustrates an example of a system which includes a computing device 100, an external computing device 200, a server computing system 300, and external content 500, which may be in communication with one another over a network 400. For example, the computing device 100 and the external computing device 200 can include any of a personal computer, a smartphone, a tablet computer, a global positioning service device, a smartwatch, and the like. The network 400 may include any type of communications network such a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the computing device 100 and/or server computing system 300 may form part of a speech recognition system which performs speech recognition of a voice input from a user of the computing device 100.

In some example embodiments, the server computing system 300 may obtain data from one or more of a speech recognition models data store 360, a POI data store 370, a navigation data store 380, and a user data store 390, to implement various operations and aspects of the speech recognition system as disclosed herein. The speech recognition models data store 360, POI data store 370, navigation data store 380, and user data store 390 may be integrally provided with the server computing system 300 (e.g., as part of the one or more memory devices 320 of the server computing system 300) or may be separately (e.g., remotely) provided. Further, speech recognition models data store 360, POI data store 370, navigation data store 380, and user data store 390 can be combined as a single data store (database), or may be a plurality of respective data stores. Data stored in one data store (e.g., the POI data store 370) may overlap with some data stored in another data store (e.g., the navigation data store 380). In some implementations, one data store (e.g., the POI data store 370) may reference data that is stored in another data store (e.g., the navigation data store 380).

Speech recognition models data store 360 can store various language models used for automatic speech recognition by speech recognition application 132 and/or speech recognition application 332 which converts human speech into text or another form of data, for example. For example, automatic speech recognition may implement natural language processing and machine learning tools (e.g., neural networks) to perform the conversion. Automatic speech recognition by speech recognition application 132 and/or speech recognition application 332 may further implement one or more acoustic models and/or one or more language models to perform the conversion. The one or more language models may be obtained from the speech recognition models data store 360. For example, the speech recognition models data store 360 may store one or more default (primary) language models which correspond to one or more default languages. For example, the one or more default languages may include one or more languages associated with the user (e.g., as indicated via a user profile via the user data store 390, by analysis of the user's speech, by an input or selection of the user via input device 150, etc.). For example, the speech recognition models data store 360 may store one or more secondary language models which correspond to one or more secondary languages. For example, the one or more secondary languages may include one or more languages other than the one or more default languages. The speech recognition application 132 and/or speech recognition application 332 may be configured to execute speech recognition with respect to a voice input or voice input in the one or more default languages via the one or more primary language models and in one or more secondary languages via the one or more secondary language models in parallel.

POI data store 370 can store information about points-of-interest, for example, for points-of-interest in an area or region associated with one or more geographic areas. A point-of-interest may include any destination or place. For example, a point-of-interest may include a restaurant, museum, sporting venue, concert hall, amusement park, school, place of business, grocery store, gas station, theater, shopping mall, lodging, and the like. Point-of-interest data which is stored in the POI data store 370 may include any information which is associated with the POI. For example, the POI data store 370 may include location information for the POI, hours of operation for the POI, a phone number for the POI, reviews concerning the POI, financial information associated with the POI (e.g., the average cost for a service provided and/or goods sold at the POI such as a meal, a ticket, a room, etc.), environmental information concerning the POI (e.g., a noise level, an ambiance description, a traffic level, etc., which may be provided or available in real-time), a description of the types of services provided and/or goods sold, languages spoken at the POI, a URL for the POI, image content associated with the POI, etc. For example, information about the POI may be obtainable from external content 500 (e.g., from webpages associated with the POI).

Navigation data store 380 may store or provide map data/geospatial data to be used by server computing system 300. Example geospatial data includes geographic imagery (e.g., digital maps, satellite images, aerial photographs, street-level photographs, synthetic models, etc.), tables, vector data (e.g., vector representations of roads, parcels, buildings, etc.), point of interest data, or other suitable geospatial data associated with one or more geographic areas. In some examples, the map data can include a series of sub-maps, each sub-map including data for a geographic area including objects (e.g., buildings or other static features), paths of travel (e.g., roads, highways, public transportation lines, walking paths, and so on), and other features of interest. Navigation data store 380 can be used by server computing system 300 to provide navigational directions, perform point of interest searches, provide point of interest location or categorization data, determine distances, routes, or travel times between locations, or any other suitable use or task required or beneficial for performing operations of the example embodiments as disclosed herein. For example, computing device 100 and/or server computing system 300 may determine relative information (e.g., a relative distance) between a POI and a location of the user, between a first POI and a second POI, etc., based on the information stored in the navigation data store 380. For example, computing device 100 may be configured to determine a first relative distance between a first POI (e.g., a first restaurant) and a second POI (e.g., a landmark), determine a second relative distance between a third POI (e.g., a second restaurant having a similar name as the first restaurant) and the second POI (e.g., the landmark). If the user indicates via a voice input a preference to travel to a restaurant closest to the second POI, the computing device 100 may be configured to determine which of the first POI and the third POI is closest to the second POI based on the determined first and second relative distances.

In some example embodiments, the user data store 390 can represent a single database. In some embodiments, the user data store 390 represents a plurality of different databases accessible to the server computing system 300. In some examples, the user data store 390 can include a current user position and heading data. In some examples, the user data store 390 can include information regarding one or more user profiles, including a variety of user data such as user preference data, user demographic data, user calendar data, user social network data, user historical travel data, and the like. For example, the user data store 390 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including purchases, electronic tickets, coupons, or deals; scheduling data; location data; SMS data; or other suitable data associated with a user account. According to one or more examples of the disclosure, such data can be analyzed to determine preferences of the user with respect to a POI, to determine preferences of the user with respect to traveling (e.g., a mode of transportation, an allowable time for traveling, etc.), to determine possible recommendations for POIs for the user, to determine possible travel routes and modes of transportation for the user to a POI, and the like.

The user data store 390 is provided to illustrate potential data that could be analyzed, in some embodiments, by the server computing system 300 to identify user preferences, to recommend POIs, to determine possible travel routes to a POI, to determine modes of transportation to be used to travel to a POI, etc. However, such user data may not be collected, used, or analyzed unless the user has consented after being informed of what data is collected and how such data is used. Further, in some embodiments, the user can be provided with a tool (e.g., in a navigation application or via a user account) to revoke or modify the scope of permissions. In addition, certain information or data can be treated in one or more ways before it is stored or used, so that personally identifiable information is removed or stored in an encrypted fashion. Thus, particular user information stored in the user data store 390 may or may not be accessible to the server computing system 300 based on permissions given by the user, or such data may not be stored in the user data store 390 at all.

External content 500 can be any form of external content including news articles, webpages, video files, audio files, written descriptions, ratings, game content, social media content, photographs, commercial offers, transportation method, weather conditions, or other suitable external content. The computing device 100, external computing device 200, and server computing system 300 can access external content 500 over network 400. External content 500 can be searched by server computing system 300 according to known searching methods and search results can be ranked according to relevance, popularity, or other suitable attributes, including location-specific filtering or promotion.

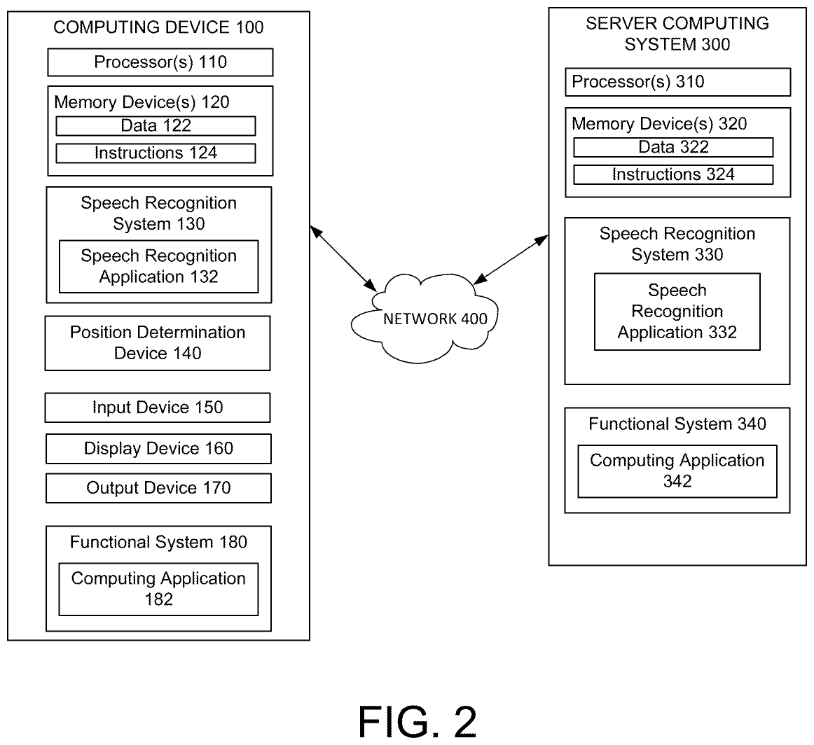

Referring now to FIG. 2, example block diagrams of a computing device and server computing system according to one or more example embodiments of the disclosure will now be described. Although computing device 100 is represented in FIG. 2, features of the computing device 100 described herein are also appliable to the external computing device 200.

The computing device 100 may include one or more processors 110, one or more memory devices 120, a speech recognition system 130, a position determination device 140, an input device 150, a display device 160, an output device 170, and a functional system 180. The server computing system 300 may include one or more processors 310, one or more memory devices 320, and a speech recognition system 330.

For example, the one or more processors 110, 310 can be any suitable processing device that can be included in a computing device 100 or server computing system 300. For example, such a processor 110, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310 can be a single processor or a plurality of processors that are operatively connected, for example in parallel.

The one or more memory devices 120, 320 can include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), a hard disk, floppy disks, a blue-ray disk, or optical media such as CD ROM discs and DVDs, and combinations thereof. However, examples of the one or more memory devices 120, 320 are not limited to the above description, and the one or more memory devices 120, 320 may be realized by other various devices and structures as would be understood by those skilled in the art.

For example, one or more memory devices 120 can store instructions, that when executed, cause the one or more processors 110 to execute a computing application (e.g., a computing application of a functional system 180 such as a navigation application of a navigation system, a climate control application of a climate control system, a media application of an infotainment system, and the like), receive a voice input from a user concerning the computing application, and process the voice input according to example methods as disclosed herein to implement a function associated with the computing application, as described according to examples of the disclosure. For example, one or more memory devices 320 can store instructions, that when executed, cause the one or more processors 310 to execute the computing application, receive the voice input from the user concerning the computing application, and process the voice input according to example methods as disclosed herein to implement a function associated with the computing application, as described according to examples of the disclosure.

One or more memory devices 120 can also include data 122 and instructions 124 that can be retrieved, manipulated, created, or stored by the one or more processors 110. In some example embodiments, such data can be accessed and used as input to execute the computing application, receive the voice input from the user concerning the computing application, and process the voice input according to example methods as disclosed herein to implement a function associated with the computing application, as described according to examples of the disclosure. One or more memory devices 320 can also include data 322 and instructions 324 that can be retrieved, manipulated, created, or stored by the one or more processors 310. In some example embodiments, such data can be accessed and used to execute the computing application, receive the voice input from the user concerning the computing application, and process the voice input according to example methods as disclosed herein to implement a function associated with the computing application, as described according to examples of the disclosure.

In some example embodiments, the computing device 100 includes the speech recognition system 130 which includes a speech recognition application 132. The speech recognition system 130 can provide speech recognition services to a user. In some examples, the speech recognition system 130 can facilitate a user's access to a server computing system 300 that provides speech recognition services via speech recognition system 330 which includes a speech recognition application 332. In some example embodiments, the speech recognition services include translating human speech into text or another data format which is usable for performing a function associated with the computing device 100 or of another device such as external computing device 200. For example, a user may be unable to provide an input manually (e.g., via a touch input to a touch-sensitive display screen) due to physical limitations or due to safety considerations (e.g., the user is driving or bicycling), and therefore the user provides a voice input via speech recognition application 132 to a computing application 182 of a functional system 180 to cause an operation or function of the functional system 180 to be performed. For example, the user may provide a voice input requesting navigation services to a destination via a navigation application of a navigation system.

In some examples, one or more aspects of the speech recognition system 130 may be implemented by the speech recognition system 330 of the server computing system 300 which may be remotely located, to provide the requested speech recognition services.

In some examples, the speech recognition system 130 can be a dedicated application specifically designed to provide speech recognition services. In other examples, the speech recognition system 130 can be a general application (e.g., a web browser) and can provide access to a variety of different services including a navigation service, a climate control service, an infotainment service, etc., via the network 400.

In some example embodiments, the computing device 100 includes a position determination device 140. Position determination device 140 can determine a current geographic location of the computing device 100 and communicate such geographic location to server computing system 300 over network 400. The position determination device 140 can be any device or circuitry for analyzing the position of the computing device 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining a position of the computing device 100.

The computing device 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), an output sound device (e.g., a speaker), a track ball, a remote controller, a portable (e.g., a cellular or smart) phone, a tablet PC, a pedal or footswitch, a virtual-reality device, and so on. The input device 150 may further include a haptic device to provide haptic feedback to a user. The input device 150 may also be embodied by a touch-sensitive display having a touchscreen capability, for example.

The computing device 100 may include a display device 160 which displays information viewable by the user (e.g., a map). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display device 160 may have a square or rectangular shape, or may be annular in shape (e.g., elliptical, circular, etc.). However, the shape of the display device 160 is not limited thereto. The display device 160 can be used by the speech recognition system 130 installed on the computing device 100 to display information to a user relating to a voice input (e.g., information relating to candidate terms corresponding to one or more terms from a plurality of terms of a voice input, navigational information, etc.). For example, the display device 160 can display a plurality of top ranked candidate terms and request a user to identify (e.g., via a voice input) one of the top ranked candidate terms as a candidate term which corresponds to a term from an initial or original voice input. Navigational information can include, but is not limited to, one or more of a map of a geographic area, the position of the computing device 100 in the geographic area, a route through the geographic area designated on the map, one or more navigational directions (e.g., turn-by-turn directions through the geographic area), travel time for the route through the geographic area (e.g., from the position of the computing device 100 to a POI), and one or more points-of-interest within the geographic area.

The computing device 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like. According to various examples of the disclosure, the user may receive feedback or queries from the speech recognition system 130 (e.g., speech recognition application 132) requesting additional information such as contextual information or confirmation information regarding candidate terms with respect to a voice input from a user as part of a disambiguation operation to correctly recognize the voice input.

The computing device 100 may include a functional system 180 that is capable of performing various operations according to instructions which are executed via computing application 182. The functional system 180 may include one or more of a navigation system, an infotainment system, a camera system, a climate control system, an engine system, an electrical system, an appliance system, an application of the functional system 180, and the like. The functional system 180 may include a computing application 182 which is configured to execute a function or operation of the functional system 180 based on the voice input received from the user and transcribed by the speech recognition application 132. For example, operations or functions associated with the one or more functional systems may include navigating to a destination, capturing an image, performing a heating or cooling operation, playing music or video, starting a vehicle, changing a lighting condition, executing a function of the computing application 182 such as opening or closing the computing application 182, etc. In some implementations, the functional system 180 or computing application 182 may include the speech recognition system 130.

In accordance with example embodiments described herein, the server computing system 300 can include one or more processors 310 and one or more memory devices 320 which were previously discussed above. The server computing system 300 may also include a speech recognition system 330. For example, the speech recognition system 330 may include a speech recognition application 332 which performs functions similar to those discussed above with respect to speech recognition application 132. The server computing system 300 may also include a functional system 340. For example, the functional system 340 may correspond to the functional system 180 discussed above and may also include a computing application 342 which performs functions similar to those discussed above with respect to computing application 182.

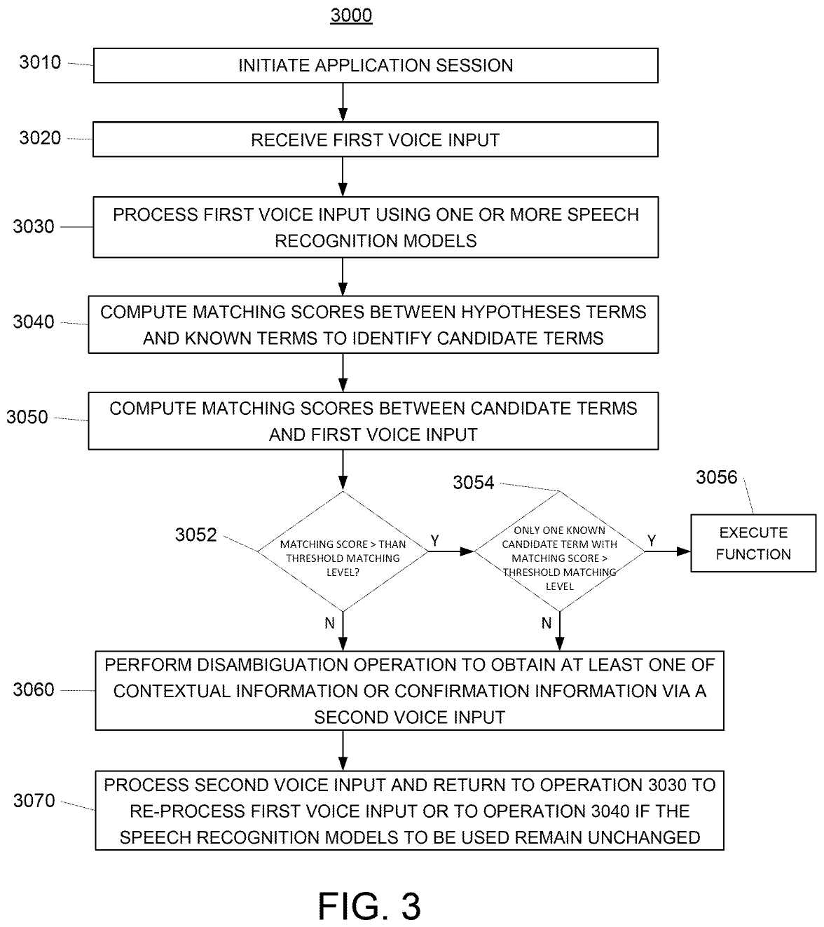

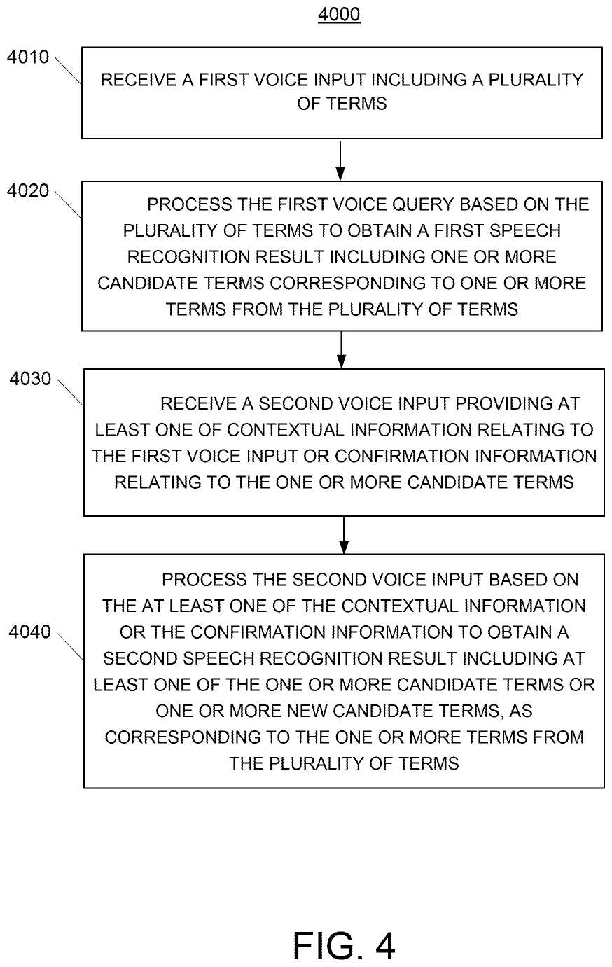

Examples of the disclosure are also directed to computer implemented methods for speech recognition and voice input disambiguation. FIGS. 3-4 illustrate flow diagrams of example, non-limiting computer-implemented methods, according to one or more example embodiments of the disclosure.

Referring to FIG. 3, in an example computer implemented method 3000 at operation 3010 the method includes initiating an application session. As a non-limiting example, a user may initiate execution of the computing application 182 via input device 150 by selecting the computing application manually via a touch input to a touch-sensitive screen, selection of a button, a keyboard command, by a voice input, or another input method. In some implementations, the computing application 182 may be triggered via an external application such as an assistant application.

In some implementations, a user may initiate execution of the computing application 182 via the voice input through a spoken hotword which identifies the application to process the voice input (e.g. “Hey ‘Name of Computing Application 182’”), or through another user interface such as a physical button (e.g., a button on a steering wheel, a touchscreen on a smartphone, a button on the user's headphones, etc.).

After the computing application 182 has been executed or initiated, at operation 3020 the computing application 182 may receive a first voice input from the user, for example, via an input device 150 such as a microphone. The first voice input may be in the form of a query or a command, for example. As a non-limiting example, when the computing application 182 corresponds to a navigation application, the first voice input may be a command such as “Navigate to Restaurant A in midtown.”

At operation 3030, speech recognition application 132 may be invoked or executed to transcribe the first voice input. For example, speech recognition application 132 may process the first voice input using one or more speech recognition models from the speech recognition models data store 360.

In some implementations, the speech recognition application 132 may be configured to process the first voice input using one or more default languages from the speech recognition models data store 360. The one or more default languages may include one or more languages of the user (e.g., as indicated via a user profile via user data store 390, by analysis of the user's speech, by an input or selection of the user, etc.).

In some implementations, the speech recognition application 132 may be configured to process the first voice input using one or more languages from the speech recognition models data store 360 which correspond to a location of the user (e.g., based on a location of the computing device 100 associated with the user as indicated by position determiner device 140 or a location provided by the user). For example, if the user's language is English a default or primary language speech recognition model applied to the first voice input by the speech recognition application 132 may include an English speech recognition model. For example, if the user is located in Switzerland, additional or secondary language speech recognition models which are applied to the first voice input by the speech recognition application 132 may include French, Italian, German, and Romansh speech recognition models.

In some implementations, the speech recognition application 132 may be configured to process the first voice input based on one or more languages from the speech recognition models data store 360 which correspond to a clue or hint provided in the first voice input itself. For example, if the first voice input indicates a language which may be relevant for purposes of transcribing the first voice input, the speech recognition application 132 may apply a speech recognition model from the speech recognition models data store 360 which corresponds to that language. For example, if the first voice input from the user is “Navigate to the French restaurant La Grenouille” the speech recognition application 132 may recognize that the first voice input includes a hint that a French speech recognition model may be helpful for purposes of transcribing the term “La Grenouille” and apply that speech recognition model from the speech recognition models data store 360. For example, the speech recognition application 132 may be configured to apply the French speech recognition model only to the term “La Grenouille” rather than to the entire first voice input. For example, when the speech recognition application 132 applies a default speech recognition model to the term “La Grenouille” a confidence level concerning the output of the transcription of the term may be below a threshold confidence level. When the confidence level concerning the output of the transcription for a particular term is less than the threshold confidence level, the speech recognition application 132 may apply a secondary speech recognition model to that particular term. For example, when an English speech recognition model is a default speech recognition model and a confidence level concerning the output of the transcription of the term “La Grenouille” is below the threshold confidence level, the speech recognition application 132 may be configured to apply the French speech recognition model as a secondary speech recognition model to the term “La Grenouille.”

For example, the speech recognition application 132 may be configured to execute speech recognition in the one or more default languages via one or more primary speech recognition models and via one or more secondary speech recognition models. For example, the one or more secondary speech recognition models may be associated with one or more languages other than the one or more default languages. For example, the one or more secondary speech recognition models may be associated with one or more languages associated with a location of the user, with one or more languages associated with the utterance (e.g., if a user identifies a country or language in the utterance itself or in an associated voice input), and the like. In some implementations, the speech recognition application 132 may be configured to execute speech recognition in the one or more default languages via the one or more primary speech recognition models and in the recognized secondary language via the one or more secondary speech recognition models in parallel.

In some implementations, the speech recognition application 132 may be configured to execute speech recognition in all available speech recognition models including the one or more primary speech recognition models for the entire utterance. In some implementations, the speech recognition application 132 may be configured to execute speech recognition in the one or more default languages via the one or more primary speech recognition models and in the one or more secondary speech recognition languages via the one or more secondary speech recognition models over the entire utterance.

In some implementations, the speech recognition application 132 may be configured to execute speech recognition in the one or more secondary languages via the one or more secondary speech recognition models for only those terms from the utterance which are identified as being in a secondary language while executing speech recognition in the one or more default languages via the one or more primary speech recognition models for the entire utterance or for the remaining terms of the utterance not being processed by the one or more secondary speech recognition models. In some implementations, the speech recognition application 132 may be configured to execute speech recognition in all available speech recognition models (other than the one or more primary speech recognition models) for only those terms from the utterance which are identified as being in a secondary language while executing speech recognition in the one or more default languages via the one or more primary speech recognition models for the entire utterance or for the remaining terms of the utterance not being processed by the one or more available speech recognition models. Limiting speech recognition by the one or more secondary speech recognition models to certain terms from the entire utterance (e.g., a term which corresponds to an object of an intent of the utterance, such as a place name, after parsing the entire utterance) which are identified as belonging to a secondary language can reduce usage of computer resources such as memory, power, and bandwidth, and can conserve the battery and/or useful life of the computing device 100 (or of other computing devices which are implemented together with the computing device 100 to perform speech recognition) which are configured to perform some or all of the operations associated with speech recognition of terms identified as belonging to the secondary language. For example, aspects of speech recognition may be executed by the computing device 100, by the server computing system 300, by the external computing device 200, or combinations thereof.

Speech recognition application 132 may produce one or more outputs with respect to the first voice input based on the one or more outputs from the one or more speech recognition models.

The speech recognition application 132 may perform a parsing operation with respect to each of the outputs obtained via the one or more speech recognition models. For example, the output of the one or more speech recognition models may be parsed using a natural language understanding model. The natural language understanding model may be any machine-learned model (e.g., a deep neural network) which extracts an intent and also slot values. The user's intent (e.g., NAVIGATE, DIRECTIONS) may be recognized to determine how the voice input should be handled. Possible transcriptions for the voice input (e.g., place name) slot value are then fed to subsequent operations (such as matching operations) which are described below. For each language N-best hypotheses terms may be provided by the speech recognition system 130, or an intermediate representation from the model may be provided rather than a textual hypothesis. In addition, specific hints that the user provides in the first voice input (or subsequent voice inputs) may be parsed. For example, hints can include information such as contextual information that can be used to update or refine the transcription(s) or obtain a new candidate transcription(s). For example, a hint for a voice input concerning a point of interest can include things like “the restaurant,” “the French restaurant,” “it's next to the lake,” etc.

In some implementations, the speech recognition application 132 may be configured to resolve all of the hypotheses terms (e.g., place name hypotheses) that are obtained from different speech recognition models for example, against known terms (e.g., known place names) that may be stored in a memory or database. The memory or database can be located on the computing device 100 (e.g., for offline mapping), or provided remotely in the cloud (e.g., at external computing device 200, server computing system 300, navigation data store 380, POI data store 370, external content 500, etc.).

At operation 3040 the speech recognition application 132 may compute matching scores between one or more hypotheses terms from the one or more outputs relating to the first voice input and known terms (e.g., known places stored in a memory or database as discussed above). For example, the matching score may represent a likelihood that an output of the speech recognition application 132 is correct and matches a known term (e.g., a known place stored in the database). The known term (e.g., known place) may be stored in a database locally on the computing device 100, or stored remotely, for example, in navigation data store 380, POI data store 370, external content 500, etc. For example, the speech recognition application 132 may be configured to perform matching between the hypotheses terms and known terms via fuzzy string matching (e.g., based on edit distance, a word error rate, or some related metric). As another example, the speech recognition application 132 may be configured to additionally (or alternatively) perform matching between the hypotheses terms and known terms via a phonetic distance to ensure that two similar sounding words have a low distance even if the edit distance would be high. For example, a threshold matching level may correspond to a value of 0.7 on a scale of 0 to 1.0, where a score of 0 indicates no match and a score of 1.0 indicates 100% matching. However, the threshold matching level may be adjusted to other values such as 0.8, 0.9, etc. When the matching score is greater than the threshold matching level, the speech recognition application 132 may determine there is a match between the hypotheses term and the known term and identify the hypotheses term as a candidate term.

In addition, or alternatively, the speech recognition application 132 may compute a confidence level between one or more hypotheses terms from the one or more outputs relating to the first voice input and known terms (e.g., known places stored in a database). For example, the confidence level may represent a likelihood that an output of the speech recognition application 132 is correct and corresponds to a known term (e.g., a known place stored in the database). The confidence level for each hypotheses term may be compared relative to confidence levels of other hypotheses terms. For example, a threshold confidence level may correspond to a value of 0.7 on a scale of 0 to 1.0, where a score of 0 indicates no match and a score of 1.0 indicates 100% matching. However, the threshold confidence level may be adjusted to other values such as 0.8, 0.9, etc. When the confidence score is greater than the threshold confidence level, the speech recognition application 132 may determine there is a match between the hypotheses term and the known term and identify the hypotheses term as a candidate term.

In some implementations, the speech recognition application 132 is configured to determine the matching score and/or confidence score based on information (i.e., hints) received by the computing device 100 (or server computing system 300) relating to the first voice input. For example, contextual information or confirmation information received by the computing device 100 (or server computing system 300) can be used by the speech recognition application 132 to implement particular speech recognition models, to filter out known terms which do not satisfy criteria indicated by the contextual information or confirmation information, etc.

At 3050, the speech recognition application 132 is configured to compute matching scores between candidate terms identified at 3040 and terms from the first voice input. For example, the speech recognition application 132 may be configured to determine (calculate) a matching score between what the user said and each candidate term (e.g., a candidate place name). Other existing ranking signals may also be incorporated.

In some implementations, if a matching score for only one of the candidate terms exceeds a threshold matching level (i.e., there is only one high scoring candidate term at operation 3054), there is no need for disambiguation (or for further disambiguation) and the speech recognition system 130 can provide an output which may be used by a functional system 180 (e.g., an electronic device such as a smartphone, a vehicle, a home appliance, etc.) to execute an operation, action, or function based on the output at 3056. In such a case the speech recognition system 130 can provide the output without a user confirmation, however in some implementations (e.g., if the function to be performed is safety related, is not time sensitive, etc.) the speech recognition system 130 may request user confirmation.

In some implementations, if a matching score for a plurality of candidate terms exceeds a threshold matching level (i.e., there are multiple high scoring candidate terms at operation 3054) the speech recognition application 132 may be configured to perform a disambiguation operation to obtain at least one of contextual information or confirmation information via a second voice input from the user, at operation 3060.

For example, if the number of such candidate terms is less than a threshold level (e.g., less than five, less than three, etc.), the speech recognition system 130 can perform the disambiguation operation by providing an output which identifies the plurality of candidate terms and requesting the user to identify or confirm one of the plurality of candidate terms as the correct selection (if it is provided).

For example, if the number of such candidate terms is more than the threshold level (e.g., more than five, more than three, etc.), the speech recognition system 130 can perform a disambiguation operation similar to a disambiguation operation performed if it is determined that none of the matching scores for the plurality of candidate terms exceed the threshold matching level (i.e., there is no high scoring candidate term) at operation 3052. For example, the speech recognition system 130 can implement a disambiguation operation to determine which candidate term to select or to determine a subset of the plurality of candidate terms to offer as possible outputs based on additional information to be provided to the speech recognition system.

For example, the disambiguation operation may include the computing device 100 (e.g., speech recognition system 130 or speech recognition application 132) causing a prompt to be generated based on a subset or pool of available candidate terms, and providing the prompt to the user (e.g., via output device 170 such as a speaker, display device 160, etc.).

For example, the speech recognition application 132 may request whether the user has a preference for a particular candidate term, identify candidate terms which may have characteristics or features that match a user preference (e.g., based on information stored in the user data store 390) or are unique or different compared to other candidate terms (e.g., a candidate term that is physically closer to the user, next to a landmark, has operating hours convenient to the user or different from other candidate terms, environmental conditions favored by the user compared to other candidate terms, etc.). For example, if multiple restaurants having the same name are located in Seattle, the speech recognition application 132 may output a prompt such as “Is it next to the Space Needle?”, to disambiguate between a restaurant located relatively closer to the Space Needle compared to the other restaurants.

For example, if the speech recognition system 130 determines the plurality of candidate terms correspond to different types of places, the speech recognition system 130 may output a prompt requesting the user to verify the type of place, such as “Did you mean the restaurant or the museum?”. As another example, different types of attributes can be used by the speech recognition system 130 to disambiguate between a plurality of candidate terms, which can be general attributes or specific to the user. For example, if the speech recognition system 130 determines one of the plurality of candidate terms is located near a landmark or geographic feature, the speech recognition system 130 may output a prompt relating to a general attribute such as “the one next to the lake?”. For example, if the speech recognition system 130 determines one of the plurality of candidate terms is located near a point of interest that is known to or preferred by the user (e.g., based on information stored in the user data store 390), the speech recognition system 130 may provide a prompt relating to a user specific attribute such as “the one next to your favorite cafe?”. For example, if the speech recognition system 130 determines one of the plurality of candidate terms has an attribute other candidate terms do not, and such an attribute is preferred by the user (e.g., based on information stored in the user data store 390), the speech recognition system 130 may output a prompt relating to the user specific attribute such as “the one with outdoor seating?”.

In response to the prompt, the speech recognition system 130 may receive further inputs from the user via the input device 150 such as a microphone, touch input, etc. In the case of a second voice input which is provided at operation 3060 in response to the prompt from the speech recognition system 130 as part of the disambiguation operation, the further utterance may be processed by executing one or more speech recognition models, parsing the output from the one or more speech recognition models, and determining matching scores between possible matches between hypotheses terms and known terms, similar to operations 3030 and 3040.

In some implementations, when the second voice input is processed attributes which are included in the second voice input may be used to select or replace speech recognition models that were used for the initial (original) voice input (the first voice input). For example, if the user states “it's an Italian restaurant” in response to receiving a prompt from the speech recognition system 130, operation 3030 may be repeated to re-process the first voice input by the speech recognition application 132 implementing an Italian speech recognition model to recognize the place name in the first voice input and may be additionally implemented to recognize terms from the second voice input. If the set of speech recognition models remain unchanged then no changes to the speech recognition models would be implemented and the speech recognition application 132 would not be executed to recognize or re-process terms from the first voice input and instead would be executed with respect to only the second voice input. Method 3000 would then return to operation 3040 to compute matching scores between hypotheses terms (which may include new hypotheses terms) and known terms (based on the information included from the output of the second voice input) to identify candidate terms and match those candidate terms with the first voice input at operation 3050. That is, in response to receiving the second voice input from the user providing the confirmation or the contextual information, the speech recognition application 132 may refine or re-rank the potential candidate terms (or obtain new candidate terms) and provide another output to the user either identifying a top ranked candidate term or requesting further information.

In some examples, the speech recognition application 132 may identify there are a plurality of possible candidate terms which correspond to a term from the original first voice input by referencing information from another application and/or data store. For example, the speech recognition application 132 may identify that the phrase “Restaurant A” from the original first voice input corresponds to a plurality of restaurants with the same name which are present in or near midtown, based on information provided via the navigation application and/or from the POI data store 370, navigation data store 380, or external content 500. In this instance, the speech recognition application 132 may determine at operation 3054 there are more than one known candidate terms with a matching score greater than the threshold matching level.

As part of a disambiguation operation, at operation 3060 the speech recognition application 132 may provide an output (e.g., via a speaker or a display) such as “There are 4 matching restaurants in midtown, all with similar travel times from your current location. Do you have any preference which one to go to?”. The user can respond with a second voice input identifying specific attributes, such as “I prefer the one close to Landmark X” or “I would prefer the one with outdoor seating.” The speech recognition application 132 may be configured to, in conjunction with a navigation application for example, process the second voice input, compute matching scores at operations 3040 and 3050, and confirm the selected choice if there is only one known candidate term with a matching score greater than the threshold matching level. For example, the speech recognition application 132 or navigation application may provide an output such as: “Ok, Restaurant A on 5th Ave is closest to Landmark X” or “Ok, Restaurant B on 8th Ave has outdoor seating” and start navigation at operation 3056 to the restaurant matching the attributes identified by the user in the second voice input.

For example, the speech recognition application 132 may process the second voice input based on the contextual information included in the second voice input by weighting a first candidate term corresponding to a first candidate point of interest more heavily compared to a second candidate term corresponding to a second candidate point of interest where the attribute information of the first candidate point of interest is more similar to attribute information associated with a first point of interest that is included in the first voice input, than the attribute information associated with the second candidate point of interest. As an example, if the second voice input indicates the user prefers a restaurant with outdoor seating, the speech recognition application 132 may weight a first candidate term corresponding to a first restaurant with outdoor seating more heavily compared to a second candidate term corresponding to a second restaurant with only indoor seating because the attribute information of the first restaurant is more similar to the attribute information associated with the restaurant uttered in the original first voice input, than the attribute information associated with the second restaurant.

For example, the speech recognition application 132 may process the second voice input based on the contextual information included in the second voice input by weighting a first candidate term corresponding to a first candidate point of interest more heavily compared to a second candidate term corresponding to a second candidate point of interest where the first candidate point of interest is physically located closer to the second point of interest than the second candidate point of interest. As an example, if the second voice input indicates the user prefers a restaurant (first point of interest) close to Landmark X (second point of interest), the speech recognition application 132 may weight a first candidate term corresponding to a first restaurant more heavily compared to a second candidate term corresponding to a second restaurant because the first restaurant is physically located closer to Landmark X (second point of interest) than the second restaurant.

For example, the speech recognition system 130 may be configured to generate a plurality of prompts in a recursive manner until only a single candidate term (e.g., a single point of interest) remains with a matching score exceeding the matching threshold level. The speech recognition system 130 can then provide an output which may be used by a functional system 180 (e.g., an electronic device such as a smartphone, a vehicle, a home appliance, etc.) to perform an operation, action, or function based on the output (e.g., start navigation, generate directions) with respect to the resolved candidate term.

Each time the speech recognition system 130 performs a successful disambiguation flow, the speech recognition system 130 can use the process as a signal for running personalized and/or federated training of speech recognition models. For example, the user's utterance may correspond to the input signal and the disambiguated candidate term (e.g., a point of interest name) may correspond to a label. In the case of personalization, the speech recognition system 130 may correctly recognize instances when the user says the same utterance in the future. In the federated setting, the change or training of the speech recognition models may be applied across the entire user population.

Referring to FIG. 4, another example computer implemented method 4000 is illustrated. For example, at operation 4010 the method includes receiving a first voice input which includes a plurality of terms. For example, the plurality of terms may indicate an intent of the user (e.g., a request for a functional system 180 to perform a function such as navigation, a request for directions, controlling a parameter of a functional system, etc.). For example, the plurality of terms may include variable information that correspond to slot values or objects of the intent (e.g., the user requesting navigation to a restaurant, a landmark, an airport, etc.). For example, the plurality of terms may include a hint which provides contextual information for applying a particular speech recognition model (e.g., an Italian restaurant), for filtering out known terms that do not correspond to the hint, and the like. For example, the first voice input may be in the form of a question or may be in the form of a command.

At operation 4020, the method may include processing the first voice input based on the plurality of terms to obtain a first speech recognition result including one or more candidate terms corresponding to one or more terms from the plurality of terms. Processing the first voice input may comprise operations similar to those described with respect to operations 3030, 3040, and 3050 (e.g., applying one or more speech recognition models, parsing the output from the one or more speech recognition models, computing matching scores between hypotheses terms and known terms, computing matching scores between candidate terms and the first voice input), and a detailed description will not be repeated for the sake of brevity.

As a non-limiting example, computing device 100 may include a speech recognition system 130 and a computing application 182 such as a navigation application, which receives a first voice input from a user such as “Navigate to La Grenouille.” The navigation application may execute the speech recognition application 132 to transcribe the first voice input using one or more speech recognition models. For example, the speech recognition application 132 may determine or infer that the term “La Grenouille” is a place based on the indicated intent of the utterance. For example, the speech recognition application 132 may determine various hypothesis terms which match known terms from available databases (e.g., navigation data store 380, POI data store 370, etc.) or from external content. For example, the speech recognition application 132 may determine that the place “La Grande Park” is a candidate term, but that a matching score for the candidate term with the first voice input is less than a threshold matching level.

In response to the speech recognition application 132 determining the matching score is less than the threshold matching level, the speech recognition application 132 may be configured to request feedback from the user, for example, by seeking clarification or confirmation regarding one or more top candidate terms, or may ask for additional, contextual, information. For example, the speech recognition application 132 may request contextual information such as the type of place associated with the first voice input or may identify one or more top candidate terms to the user to obtain a confirmation from the user regarding the top candidate terms (e.g., “What type of place is it? I found La Grande Park in New Jersey”). The user may provide a second voice input providing the confirmation or the contextual information in response to the prompt from the speech recognition application 132.

For example, at operation 4030 the speech recognition application 132 may be configured to receive a second voice input providing at least one of contextual information relating to the first voice input or confirmation information relating to the one or more candidate terms. Referring back to the non-limiting example, the user may provide a second voice input responding to the prompt from the speech recognition application 132 providing contextual information (e.g., “It's a restaurant”).

For example, at operation 4040 the speech recognition application 132 may be configured to process the second voice input based on the at least one of the contextual information or the confirmation information to obtain a second speech recognition result including at least one of the one or more candidate terms or one or more new candidate terms, as corresponding to the one or more terms from the plurality of terms from the original first voice input. Referring back to the non-limiting example, the speech recognition application 132 may be configured to process the second voice input (e.g., “It's a restaurant”) to filter out candidate terms and/or to obtain new candidate terms. For example, the speech recognition application 132 may determine a second speech recognition result which includes one or more candidate terms or one or more new candidate terms (“I've found La Grande Boucherie or La Grenouille”).

When the number of candidate terms identified as corresponding to a term from the original first voice input is more than one as in the non-limiting example, the user may provide another (third) voice input (similar to operation 4030) responding to the prompt from the speech recognition application 132 providing confirmation or contextual information (e.g., “the second one” and/or “it's next to my favorite chocolate shop”). The speech recognition application 132 may process the further (third) voice input from the user providing the confirmation or the contextual information (similar to operation 4040), to confirm the selection of the candidate term to the user and/or confirm that the selected candidate term is associated with the contextual information (e.g., “Navigating to La Grenouille” and/or “It's on the same block as Neuhaus Belgian Chocolate”). For example, the speech recognition application 132 may access the user data store 390 to determine the user's favorite chocolate shop and may access the navigation data store 380 and/or POI data store 370 to determine which of the candidate terms is closer to the user's favorite chocolate shop.

As described in the above-example, possible matches between the hypotheses terms and known terms may be refined based on additional information (i.e., hints) provided via the user. For example, a user may provide an input confirming certain information or may provide contextual information or attribute information which can be applied by the speech recognition application 132 to filter down the possible matches between the hypotheses terms and known terms and to obtain a single candidate term having a matching score with the original first voice input which exceeds the threshold matching level. In some implementations, the additional information can be applied before a matching operation is performed. For example, a user may specify Restaurant A is in the south part of City A or is a French restaurant in City A. The speech recognition application 132 may be configured to consider a subset of restaurants in City A rather than all of the restaurants in City A when comparing the hypotheses restaurants against known restaurants. Such a filtering operation prior to the matching operation can improve efficiencies of the speech recognition system 130 and conserve or reduce usage of computing resources. The additional information (i.e., hints) provided by the user may be matched against precomputed attributes for each known term. For example, attribute information may be associated with a term (e.g., a place) via various methods. For example, such attribute information may be determined based on information associated with a user profile (e.g., user preferences such as favorite restaurants, favorite foods or places, modes of travel of the user, etc.) as stored in the user data store 390, information associated with mapping data (e.g., determining a relative location of a point of interest to another point of interest, to a city center, etc.) as stored in the navigation data store 380 and/or POI data store 370, information associated with a term that is obtained from an external data source such as webpages, analysis of imagery or photos, etc. (e.g., hours of operation, real-time conditions, weather information, time information, etc.) as made available via external content 500. For example, a user may provide contextual information about a first point of interest that can resolve an ambiguity between two candidate points of interest (e.g., “it's the restaurant next to my favorite music store”).

When only a single candidate term is obtained having a matching score with the original first voice input which exceeds the threshold matching level, the speech recognition application 132 may provide an output which can be used to execute a function in association with the confirmed voice input. In the non-limiting example, the navigation application may perform a function of navigating to the identified and disambiguated destination of La Grenouille.

To the extent such as terms “module”, and “unit,” and the like are used herein, such terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blue-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A method, comprising:
receiving a first voice input including a plurality of terms;
processing the first voice input based on the plurality of terms to obtain a first speech recognition result including one or more candidate terms corresponding to one or more terms from the plurality of terms;
receiving a second voice input providing at least one of contextual information relating to the first voice input or confirmation information relating to the one or more candidate terms; and
processing the second voice input based on the at least one of the contextual information or the confirmation information to obtain a second speech recognition result including at least one of the one or more candidate terms or one or more new candidate terms, as corresponding to the one or more terms from the plurality of terms.

2. The method of claim 1, further comprising requesting the at least one of the contextual information relating to the first voice input or the confirmation information relating to the one or more candidate terms.

3. The method of claim 1, wherein processing the first voice input comprises implementing one or more speech recognition models with respect to the first voice input.

4. The method of claim 3, wherein implementing the one or more speech recognition models with respect to the first voice input includes implementing a plurality of speech recognition models with respect to the first voice input including:
implementing a first speech recognition model among the plurality of speech recognition models with respect to at least a portion of an entire utterance associated with the first voice input, and
implementing a second speech recognition model among the plurality of speech recognition models with respect to at least the portion of the entire utterance associated with the first voice input.

5. The method of claim 4, wherein
the first speech recognition model corresponds to a default language associated with a user providing the first voice input, and
the second speech recognition model corresponds to a language associated with a location of the user providing the first voice input.

6. The method of claim 4, wherein
the first speech recognition model corresponds to a default language associated with a user providing the first voice input, and
the second speech recognition model corresponds to a language, other than the default language, which is associated with the one or more terms from the plurality of terms.

7. The method of claim 4, wherein
the first speech recognition model corresponds to a default language associated with a user providing the first voice input, the first speech recognition model being implemented with respect to the entire utterance associated with the first voice input, the second speech recognition model corresponds to a language other than the default language, and
when a recognition confidence of the first speech recognition model with respect to portions of the entire utterance associated with the first voice input is less than a threshold confidence level, the method comprises implementing the second speech recognition model with respect to the portions of the entire utterance associated with the first voice input.

8. The method of claim 4, wherein
the first speech recognition model corresponds to a default language associated with a user providing the first voice input, the first speech recognition model being implemented with respect to the entire utterance associated with the first voice input, and
the second speech recognition model is implemented with respect to portions of the entire utterance associated with the first voice input which are in a language other than the default language.

9. The method of claim 1, wherein
the one or more terms include information associated with a first point of interest,
the contextual information includes a second point of interest associated with the first point of interest, and
processing the second voice input based on the contextual information includes determining whether the second point of interest is associated with the at least one of the one or more candidate terms or the one or more new candidate terms.

10. The method of claim 9, wherein processing the second voice input based on the contextual information includes weighting a first candidate term corresponding to a first candidate point of interest more heavily compared to a second candidate term corresponding to a second candidate point of interest, wherein the first candidate point of interest is physically located closer to the second point of interest than the second candidate point of interest.

11. The method of claim 1, wherein
the one or more terms include information associated with a first point of interest,
the contextual information includes attribute information about the first point of interest, and
processing the second voice input based on the contextual information includes determining whether the at least one of the one or more candidate terms or the one or more new candidate terms is associated with the attribute information.

12. The method of claim 11, wherein
processing the second voice input based on the contextual information includes weighting a first candidate term corresponding to a first candidate point of interest more heavily compared to a second candidate term corresponding to a second candidate point of interest, and
attribute information of the first candidate point of interest is more similar to the attribute information associated with the first point of interest than attribute information associated with the second candidate point of interest.

13. The method of claim 1, further comprising:
determining respective matching scores between a first term from the plurality of terms included in the first voice input and each candidate term corresponding to the first term; and
providing a prompt to a user associated with the first voice input, the prompt requesting at least one of contextual information relating to the first term or confirmation information relating to each candidate term corresponding to the first term, in response to determining none of the respective matching scores exceed a threshold matching level or in response to determining a plurality of the respective matching scores exceed the threshold matching level.

14. The method of claim 13, wherein when each candidate term is associated with a different type of point of interest, providing the prompt requesting at least one of contextual information relating to the first term or confirmation information relating to each candidate term corresponding to the first term includes providing a prompt to the user to identify a type of point of interest associated with the first term.

15. The method of claim 13, wherein when a candidate term is associated with a differentiating attribute, providing the prompt requesting at least one of contextual information relating to the first term or confirmation information relating to the candidate term corresponding to the first term includes providing a prompt to the user to identify whether the differentiating attribute is associated with the first term.

16. The method of claim 1, wherein
processing the first voice input comprises implementing one or more speech recognition models with respect to the first voice input, and
when the second voice input includes at least one term associated with one or more languages different from languages associated with the one or more speech recognition models, the method comprises re-processing the first voice input by implementing one or more further speech recognition models with respect to the first voice input to obtain the second speech recognition result.

17. A speech recognition system, comprising:
at least one memory to store instructions; and
at least one processor configured to execute the instructions to perform operations, the operations comprising:
receiving a first voice input including a plurality of terms,
processing the first voice input based on the plurality of terms to obtain a first speech recognition result including one or more candidate terms corresponding to one or more terms from the plurality of terms,
receiving a second voice input providing at least one of contextual information relating to the first voice input or confirmation information relating to the one or more candidate terms, and
processing the second voice input based on the at least one of the contextual information or the confirmation information to obtain a second speech recognition result including at least one of the one or more candidate terms or one or more new candidate terms, as corresponding to the one or more terms from the plurality of terms.

18. The speech recognition system of claim 17, wherein the operations further comprise:
determining respective matching scores between a first term from the plurality of terms included in the first voice input and each candidate term corresponding to the first term, and
providing a prompt requesting at least one of contextual information relating to the first term or confirmation information relating to each candidate term corresponding to the first term, in response to determining none of the respective matching scores exceed a threshold matching level or in response to determining a plurality of the respective matching scores exceed the threshold matching level.

19. A computing system, comprising:
a speech recognition system, comprising:
at least one memory to store instructions, and
at least one processor configured to execute the instructions to perform operations, the operations comprising:
receiving a first voice input including a plurality of terms,
processing the first voice input based on the plurality of terms to obtain a first speech recognition result including one or more candidate terms corresponding to one or more terms from the plurality of terms,
receiving a second voice input providing at least one of contextual information relating to the first voice input or confirmation information relating to the one or more candidate terms, and
processing the second voice input based on the at least one of the contextual information or the confirmation information to obtain a second speech recognition result including at least one of the one or more candidate terms or one or more new candidate terms, as corresponding to the one or more terms from the plurality of terms; and
a functional system configured to execute one or more operations of the computing system in response to a matching score between the second speech recognition result and the one or more terms from the plurality of terms exceeding a threshold matching level.

20. The computing system of claim 19, wherein the operations further comprise:
determining respective matching scores between a first term from the plurality of terms included in the first voice input and each candidate term corresponding to the first term, and
providing a prompt requesting at least one of contextual information relating to the first term or confirmation information relating to each candidate term corresponding to the first term, in response to determining none of the respective matching scores exceed the threshold matching level or in response to determining a plurality of the respective matching scores exceed the threshold matching level.
